(19) United States
(12) Patent Application Publication
(10) Pub. No.: US 2025/0165897 A1
(43) Pub. Date: May 22, 2025

(54) Computer-implemented Method for Real-Time Group Membership Tracking and Related System

(71) Applicant: Klaviyo, Inc., Boston, MA (US)

(72) Inventors: Michael Boker, New York, NY (US); Anton Rodionov, The Hague (NL); Dave Hagman, Boston, MA (US)

(21) Appl. No.: 18/518,238

(22) Filed: Nov. 22, 2023

(51) Int. Cl. G06Q 10/0639; G06F 16/23

(52) U.S. Cl. CPC G06Q 10/06393; G06F 16/2365

(57) ABSTRACT

A computer-implemented method for tracking membership of a collection based on new records corresponding to new membership change events. The method comprises receiving a batch of new records for membership change events from a segmentation engine; preprocessing the new records and historic records to exclude invalid membership change events; creating a normalized data table of the valid membership change events; and sending the normalized data table to an analytics processing database for computing at least one metric for the collection based on the normalized data table. Optionally, the collection is an audience and the metric is segment growth. Related computer systems are described.

### TECHNICAL FIELD

This generally relates to computer data processing, and more particularly, to computer-implemented methods for evaluating historical membership change events in real-time.

### BACKGROUND

Group membership tracking is the process of keeping track of members of a group or organization. It involves maintaining a comprehensive database of members, their personal information, and their membership status.

Tracking group memberships and historical changes is challenging for a number of reasons not the least of which is accurately recording membership change events (e.g., member added/removed). In a large-scale system, recording valid change events is a computationally difficult problem. The challenge arises because it is difficult to be 100% certain of the validity of incoming events. For example, an event publisher associated with a segmentation engine may be prone to publishing duplicate events or events with some delay. Any time a change event is recorded, there needs to be a lookup on any previous change events for that item and collection, to validate that this new event constitutes a real change. To illustrate by example: if an event indicates that an item has been added to a collection, a check is required to see that the item was not already present in the collection before accepting the new event—the item cannot be added to a collection in which it is already present.

The possibility of late-arriving events complicates this process, because an event that is not valid at the time it arrives may later become valid due to late-arriving events. For example, if an event (e.g., Event 1) is received that indicates an item was removed from a collection, but there is no record of that item being in the collection, then Event 1 needs to be ignored. But later, if an event (e.g., Event 2) is received with a timestamp preceding that of Event 1, and Event 2 indicates that the item in question was added to the collection, then both of these events should now be considered valid. Such late-arriving events can occur due to the nature of distributed computing. For example, Event 1 was transmitted by one server that is in good health and not undergoing any delays, while Event 2 was transmitted by a different server that is under a higher computational load and is struggling to keep up-to-date. These late-arriving events can also occur if there is some outage or other issue that requires a backfill of data for a time period in the past.

Group membership and membership change event tracking also requires filtering and aggregating capabilities.

To perform these computations on the database takes time and has a very high computational load. Depending on the number of records or events, tracking is thwarted for being too slow or impractical to observe the information. If the analytic database is required to determine validity of the all the membership change events in the collection as well as compute metrics, the computational load shall be too high, and real time membership tracking metrics shall be unavailable.

Accordingly, a method and system that addresses the above-mentioned challenges is desired.

### SUMMARY OF THE INVENTION

An embodiment of the invention is a computer-implemented method of tracking membership of a collection based on new records. The method comprises: reading the new records for membership change events; preprocessing the new records to create a normalized data table; sending the normalized data table to an analytics processing database; and computing, on the analytics processing database, at least one metric for the collection based on the normalized data table.

In embodiments of the invention, the preprocessing step comprises: reading historic records for memberships present in the new records; creating normalized records by filtering out invalid records from the historic records and new records; and writing the normalized records to the normalized data table.

In embodiments of the invention, the computing comprises computing size of the collection.

In embodiments of the invention, the computing comprises computing population of the collection.

In embodiments of the invention, the computing comprises computing changes in population for the collection for a time period.

In embodiments of the invention, the method further comprises displaying growth of the collection or at least one channel performance metric. Examples of channel performance metrics include, without limitation, revenue attributed to email, email open rate, click rate, and placed order rate.

In embodiments of the invention, the change events comprise members added and members removed, and the filtering the invalid change events comprises removing change events corresponding to duplicative members added or removed.

In embodiments of the invention, the collection is an audience.

In embodiments of the invention, the method further comprises continuously reading new records, and generating an initial set of records of membership change events after beginning the reading of new records.

In embodiments of the invention, the initial set of records is generated based on previously stored membership data of the collection.

In embodiments of the invention, the method further comprises creating a history table comprising historical records, and wherein all the new records are written to the history table.

In embodiments of the invention, each new change event comprises an ingestion time, timestamp, profile ID, segment ID, and an event type.

In embodiments of the invention, the analytics processing database is an OLAP database, optionally Clickhouse.

In embodiments of the invention, a computer-implemented method of tracking membership of a collection comprises: reading new membership change events as each new membership change event is ingested; updating a first table of membership change events with each new membership change event; creating a second table of membership change events by removing invalid change events from the first table, wherein the second table comprises a listing of valid membership change events; sending the second table to an analytics processing database; and computing, on the analytics processing database, at least one metric for the collection based on the normalized table.

In embodiments of the invention, the membership change events comprise members added and members removed, wherein removing the invalid change events comprises removing change events corresponding to duplicative members added or removed.

In another embodiment of the invention, a system is operable to track membership in collections in real time. The system comprises one or more processors that collectively are programmed and operable to collect events corresponding to a collection, filter out the invalid events, store only valid event data, and aggregate the valid event data to determine various characteristics or metrics for the collection.

Examples of metrics include the size of the collection at a point in time; the population of the collection (e.g., which items are present in the collection); and the items that were added and/or removed from the collection over a time interval.

In embodiments of the invention, the aggregation is performed very quickly over the relevant time period because the validity of the events (and the applicable logic rules) are not performed during the aggregation of the data phase. The determination of the valid events are preprocessed, prior to the aggregation.

In embodiments of the invention, the collection is an audience.

In embodiments of the invention, a computer-implemented system for tracking membership of a collection comprises: a new change event data repository where new membership change events are received and recorded to a raw event table; a historical change event data repository where the new membership change events and existing membership change events are saved in a historical event table; a normalizer module operable to create a normalized event table by filtering out invalid membership change events from the historical event table; a normalized change event data repository for recording a normalized event table; and a database management system operable to compute at least one metric based on the normalized event table from the normalized change event data repository.

In embodiments of the invention, the database management system is operable to compute the population of the collection.

In embodiments of the invention, the normalizer module is operable to filter out invalid memberships based on comparing the new membership change events to all change events in the historical event table.

In embodiments of the invention, the population is an audience.

In embodiments of the invention, the processor is programmed and operable to display growth of the collection.

In another embodiment of the invention, one or more non-transitory computer-readable media or product having instructions stored thereon that, when executed by one or more processors of a computing device, cause the one or more processors to perform operations comprising: to read new records for membership change events; to preprocess the new records to create a normalized data table, wherein the preprocessing comprises: reading historic records for memberships present in the new records; creating normalized records by filtering out invalid records from the historic records; and writing the normalized records to the normalized data table; and to send the normalized data table to an analytics processing database for computing at least one metric for the collection based on the normalized data table.

In another embodiment, a method of tracking group membership on a graphical user interface (GUI) of a computer system comprises: receiving, via the GUI of the computer system, a user selection for a group metric; computing, by an online analytic processing (OLAP) database, the group metric based on the user selection and a preprocessed membership change event dataset based only on valid membership change event records; and automatically displaying the group metric on the GUI based on the user selection.

In embodiments, the GUI is implemented in a portable computing device such as a tablet, mobile phone, or laptop.

In embodiments, a normalizer engine automatically receives new membership change event records for the group and prepares the preprocessed membership change event dataset.

In embodiments, the preparing the preprocessed membership change event dataset comprises automatically filtering out invalid change events.

In embodiments, the method further comprises sending the preprocessed membership change event dataset from the normalizer engine to the OLAP database.

In embodiments, the computing step is performed in less than one (1) second.

In embodiments, the preprocessed membership change event dataset is prepared in less than one (1) minute by the normalizer engine.

In embodiments, the user selection comprises at least one selected from: a date range, an interval, and a conversion metric.

In embodiments, the group metric is at least one of the following: segment growth, added/dropped members from segment, and segment growth by day, dollars ($) spent by segment members, revenue per email recipient, emails received, open rate, click rate, and placed order rate.

In embodiments, the user selection is an interval, and the interval is selected from seconds, minutes, hours, days, weeks, months, and years.

In embodiments, the user selection is conversion metric, and the conversion metric is a placed order.

In embodiments, the method further comprises at the time the user selection is received via the GUI, querying whether any new change event records have been received since the preprocessed membership data set was previously prepared. If a new change event record has been received, then the method updates the preprocessed membership data set before sending to the OLAP database. If no new change event records have been received since the preprocessed membership data set was previously prepared, then the method does not update the preprocessed membership data set before sending to the OLAP database.

In embodiments, the processor is programmed and operable to display growth of the collection responsive to a user selection.

In embodiments, the system further comprises a computing device programmed and operable with the database management system to receive a user selection, and to display the metric.

In embodiments, the computing device is a portable computing device selected from the group consisting of a tablet and mobile phone.

In embodiments, the system further comprises a segmentation engine programmed and operable to define a member segment based on a user instruction or behavior.

In embodiments, the segmentation engine is further programmed and operable to determine a new membership change event based on automatically detecting an action of a sub-user, and to write the new membership change event to the raw data repository for preprocessing.

In embodiments, data partitioning is applied to manage the data in one or more of the database tables.

In embodiments, a time-based partitioning scheme is applied to the data in the landing table such that all of the data in the landing table is stored in a directory structured by time (e.g., year/month/day/hour). Without intending to be bound to theory, this is important because the data can be collocated based on temporal proximity (i.e., events that happened around the same time are stored near each other). Consequently, new data may be quickly and efficiently ingested because the component that is ingesting the data has to only update a small number of files in a specific directory, rather than search all over the dataset for where it should be writing new rows.

In contrast, in embodiments, the intermediary or history table does not use partitioning. In embodiments, all of the data in the history table is located in files that are stored in one ‘big’ directory. This is because for every run of the normalizer, described herein, it potentially will have to look back over the entire history of the dataset for historic records of each membership in the new data. If we partitioned by time, then very many potentially small files would have to be scanned to look for data relevant to the new events. Partitioning by time was found to be very inefficient.

In embodiments, the data in the history table is managed by a clustering scheme. In embodiments, clustering is based on the audience ID and profile ID, such that all events for an audience ID and profile ID are stored near each other in the data files. In contrast, partitioning the history table by time would make searching for the audience ID and profile ID essentially impossible.

In embodiments, the normalized table has partitioning by time similar to the landing table because most of the data written to it will be from the most recent hour, and this makes writing more efficient for the normalizer.

### Objects and Advantages

Embodiments of the invention have a variety of objects and advantages. For example, embodiments of the invention can perform the “heavy lifting” necessary for organizing valid and invalid events in a preprocessing pipeline that can process such events end-to-end in single digit minutes. Then, queries from the final database can be processed in milliseconds or low single digit seconds. The preprocessing pipeline organizes valid data events and excludes invalid data events. Downstream from the preprocessing pipeline, the data is stored in a database (e.g., an OLAP database) where the events can be aggregated quickly with minimal data needing to be transferred between compute nodes of the database.

Embodiments of the subject invention solve the problem of filtering collection change events in a near-real-time pipeline, and storing them in a database so the change events can be aggregated within a threshold amount of time suitable for various user interface (UI) use cases. In embodiments of the invention, the threshold amount of time is under 1-2 seconds.

In contrast, applying logic rules to organize the valid and invalid events in the aggregator database management system takes too long to process, takes too long to be made available for our users, and/or the time to run queries on the data is prohibitively slow for UI use cases, and potentially too computationally demanding to be economically viable. It is an object to overcome these processing challenges.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings in which:

FIG. 1 shows a schematic diagram of a group membership tracking system, according to one or more embodiments of the present invention;

FIG. 2 is a flow chart of a filter or normalizer module, according to one or more embodiments of the present invention;

FIG. 3 shows an example of an event landing table for sequential ingestion times (a)-(e), according to one or more embodiments of the present invention;

FIG. 4A shows an example of a history table for sequential ingestion times (a)-(e), according to one or more embodiments of the present invention;

FIG. 4B shows an example of a condensed history table and normalized table for sequential ingestion times (a)-(e), according to one or more embodiments of the present invention;

FIG. 5 is a GUI showing a segment growth report, according to one or more embodiments of the present invention

FIG. 6 is a GUI showing an audience performance report, according to one or more embodiments of the present invention; and

FIG. 7 is a block diagram of a computing system that can implement techniques described herein, according to one or more embodiments of the present invention.

### DETAILED DESCRIPTION

Before the present invention is described in greater detail, it is to be understood that this invention is not limited to particular embodiments described, and as such can, of course, vary. It is also to be understood that the terminology used herein is for the purpose of describing particular embodiments only, and is not intended to be limiting, since the scope of the present invention will be limited only by the appended claims. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention. Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described. It is noted that, as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation. As will be apparent to those of skill in the art upon reading this disclosure, each of the individual embodiments described and illustrated herein has discrete components and features which can be readily separated from or combined with the features of any of the other several embodiments without departing from the scope or spirit of the present invention. Any recited method can be carried out in the order of events recited or in any other order that is logically possible.

All existing subject matter mentioned herein (e.g., publications, patents, patent applications and hardware) is incorporated by reference herein in its entirety except insofar as the subject matter may conflict with that of the present invention (in which case what is present herein shall prevail).

Described herein are various methods and systems for tracking group memberships, and in preferred embodiments, tracking audience memberships.

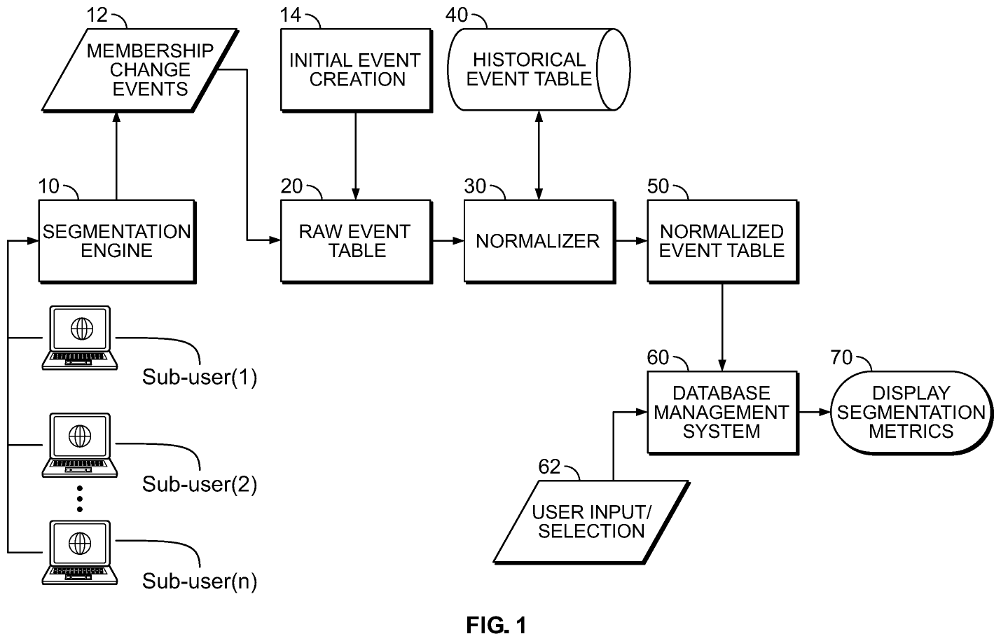

FIG. 1 shows a schematic diagram of a group membership tracking system, according to one or more embodiments of the present invention.

Step 12 states segmentation change events. This step can be performed by a segmentation engine 10 which emits member change events for an audience or segment. The segment may be defined and selected as desired by the system user (also referred to herein as a subscriber).

In embodiments, the segmentation engine 10 is operable to determine membership and membership change events based on the sub-user's (sub-user₁, sub-user₂, . . . sub-userₙ) information/behavior and in some embodiments, regardless of whether the information is input by the sub-user (e.g., via an electronic form) or is automatically detected as described herein. In some implementations, the system receives behavior information through a data pipeline comprising one or more integration systems or APIs with the sub-users. Non-limiting examples of segmentation engines are described in U.S. Pat. Nos. 7,805,332 and 7,698,163, each of which is incorporated herein by reference in its entirety for all purposes.

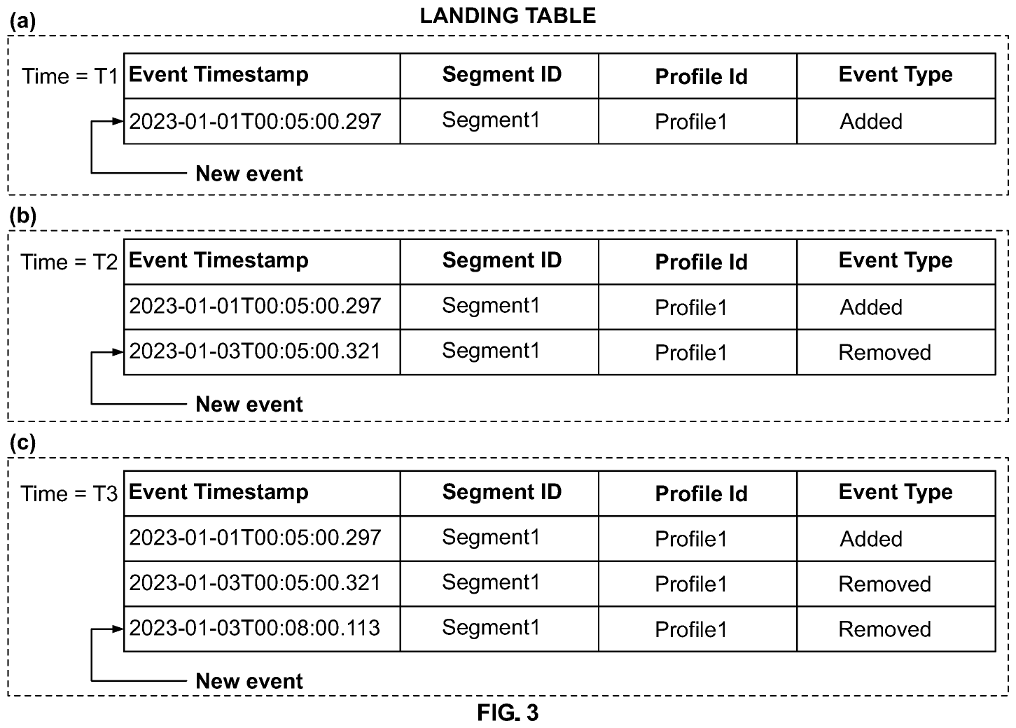

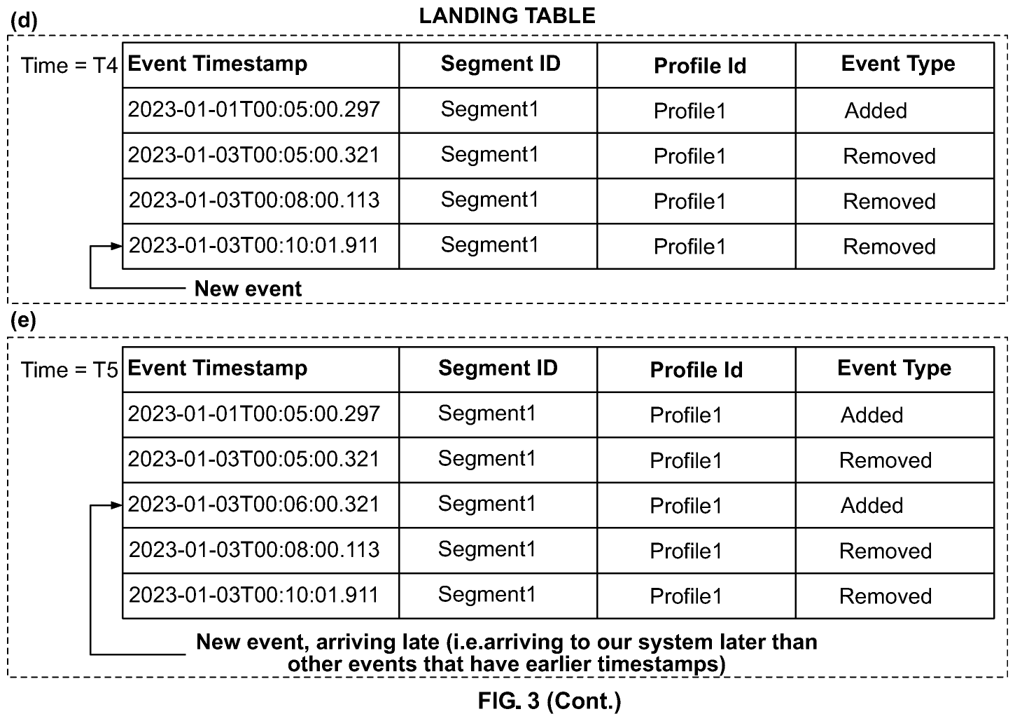

Change events (e.g., member added, member removed) for the audience/segment are received by the raw event table 20. In embodiments, and with reference to FIG. 3, the raw event table 300 includes for each ingestion time T1-T5: a timestamp, audience ID (e.g., segment ID), member profile ID (e.g., business/entity ID), and event type (e.g., member added/removed to the segment). Each newly ingested event is shown being added (or inserted as the case may be) to the raw event table according to the order of its timestamp.

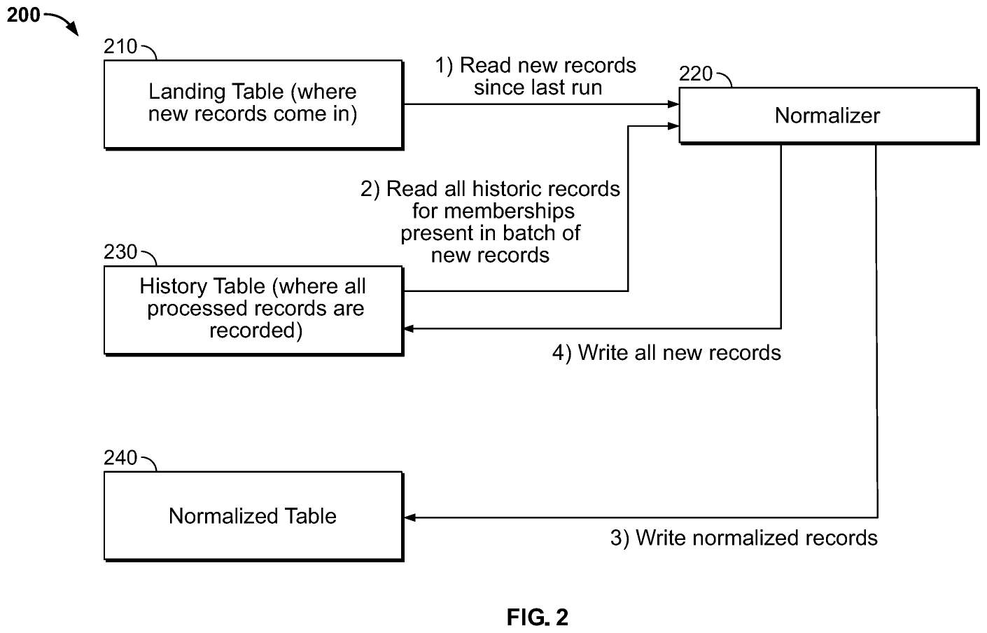

With reference again to FIG. 1, the updated raw event table 20 is provided to the normalizer 30 for preprocessing prior to sending to the database management system 60 for aggregation. The normalizer 30, as discussed further herein in connection with FIGS. 2-4, is programmed and operable to filter or condense the raw event table based on using the historical event table 40 and normalized event table 50 prior to sending to the database management system 60. The inventors have found that preprocessing the event data in the normalizer 30 tremendously reduces the number of records to be aggregated, and allows the aggregator 60 to be able to aggregate and compute various metrics in real-time or near real-time. In embodiments, each of the raw event table, historical table and normalized table are stored in one or more data lakes or another type of data storage repository.

Database management system 60 is programmed and operable to aggregate the event data, and in embodiments, to do so based on user input/selection 62. A wide range of database management systems may be implemented to aggregate and compute different metrics. An exemplary database management system 60 is ClickHouse or ClickHouse Cloud, both by ClickHouse, Inc. (Amsterdam, NL).

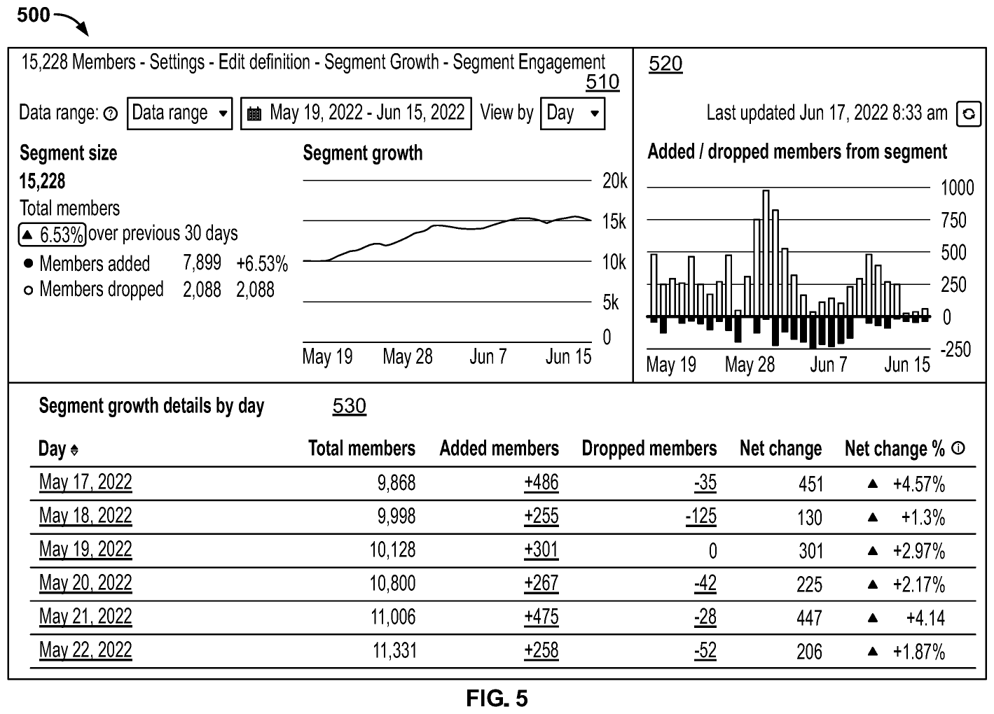

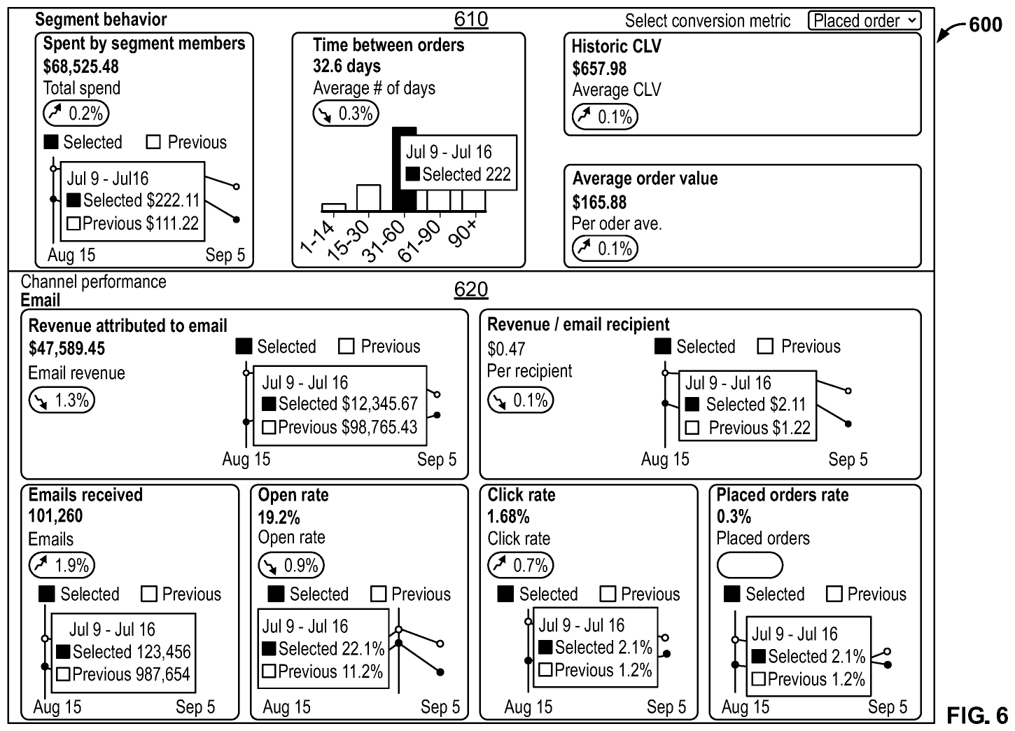

Step 70 states to display segmentation metrics. As described further herein with reference to FIGS. 5-6, a wide range of segmentation metrics may be output or displayed. In embodiments, a user may input/select 62 which metrics are to be computed via a GUI, and the database management system 60 computes in real-time the desired metrics. The GUI then displays the computed metrics 70, described further herein.

FIG. 1 also shows step 14 for initial event creation or “data initialization.” In embodiments of the invention, snapshots are taken of the various membership databases at some time after the start of collecting the new change events. These established databases provide all the data needed to discern the membership of every segment at the time the snapshots are taken. This membership data is used to create change events in the system indicating the addition of each member in each segment. In embodiments, the existing historical table and normalized table are populated from the snapshots of the existing membership databases. The system thus has a record, albeit artificially created, of the membership for each segment that existed before new change events occurred.

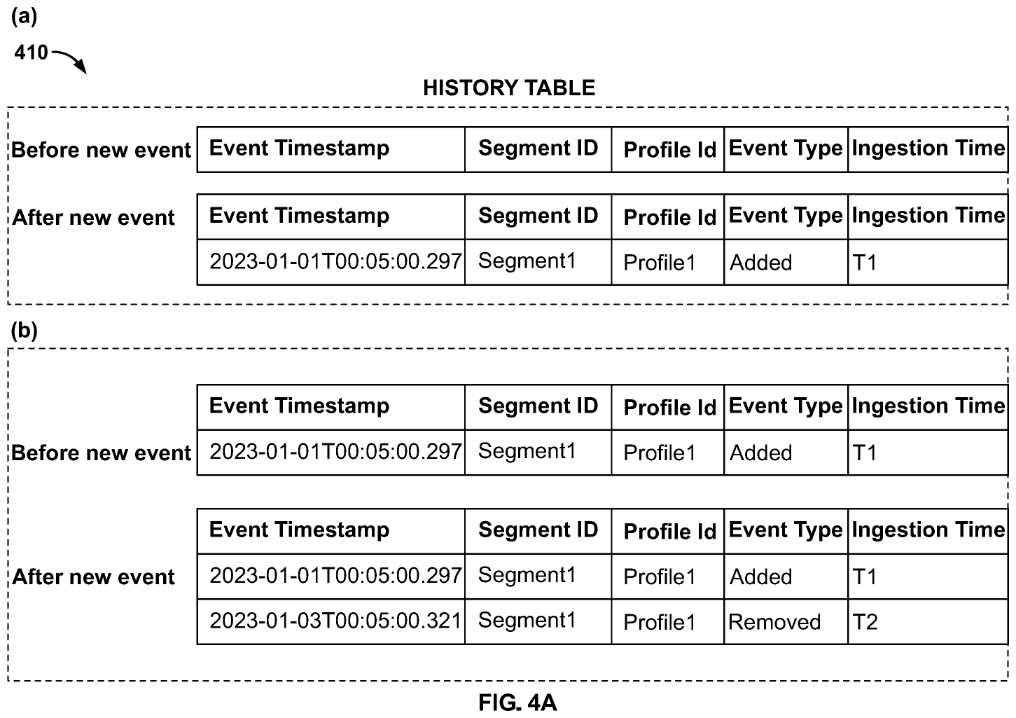

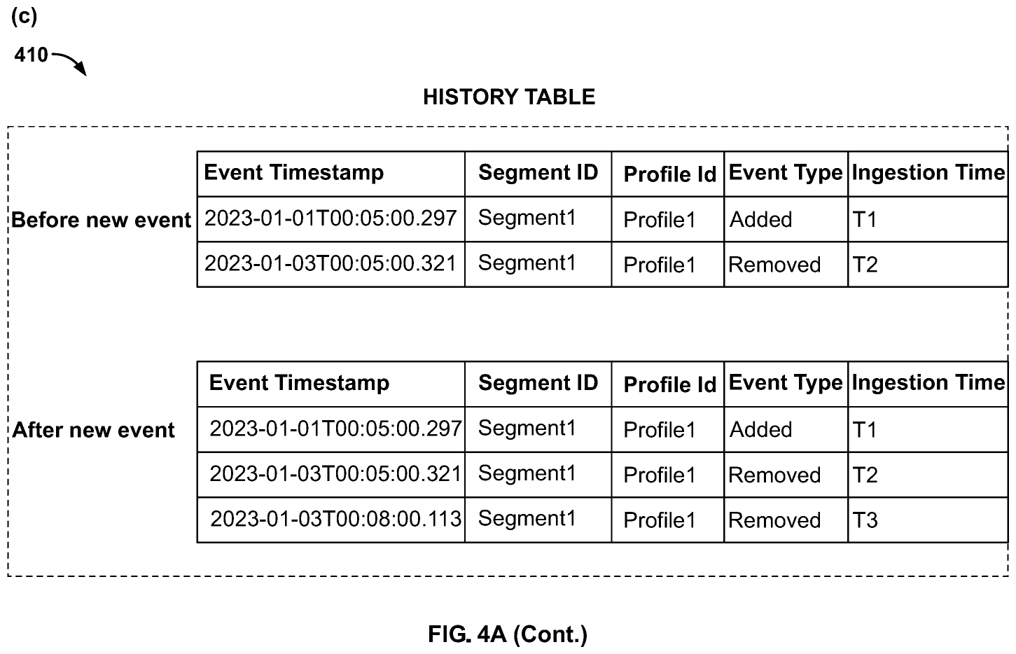

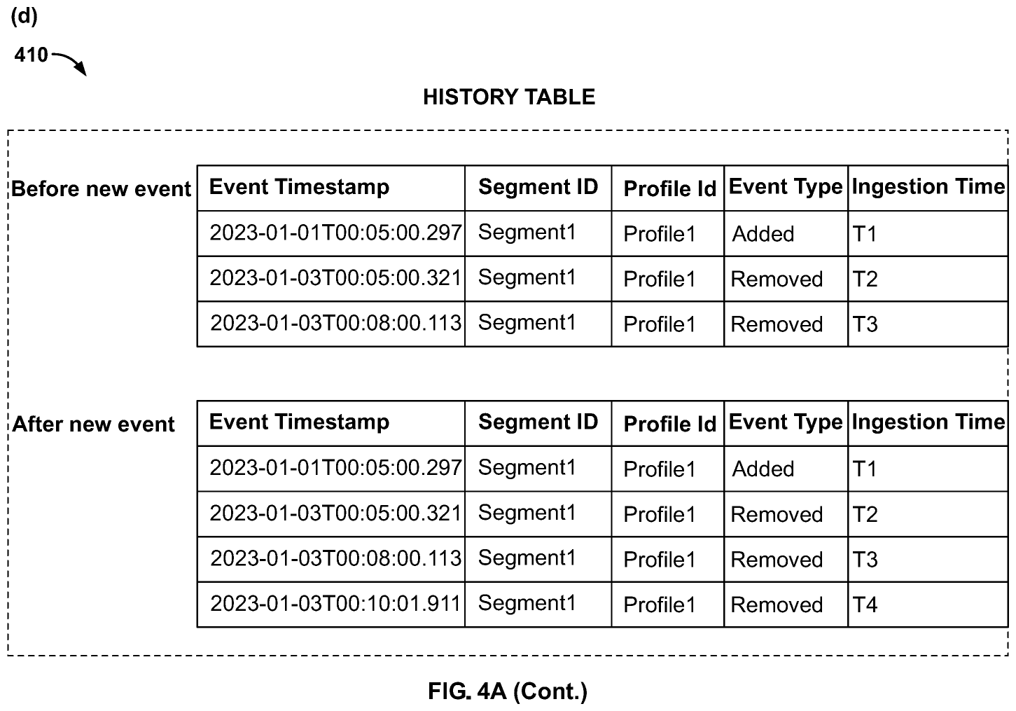

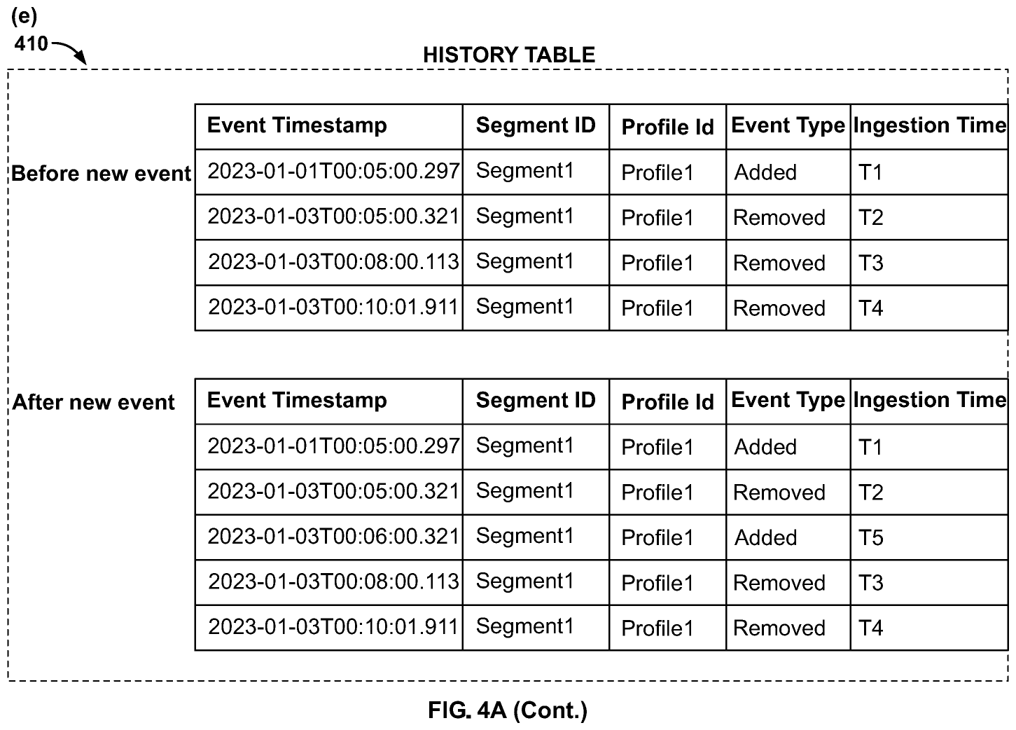

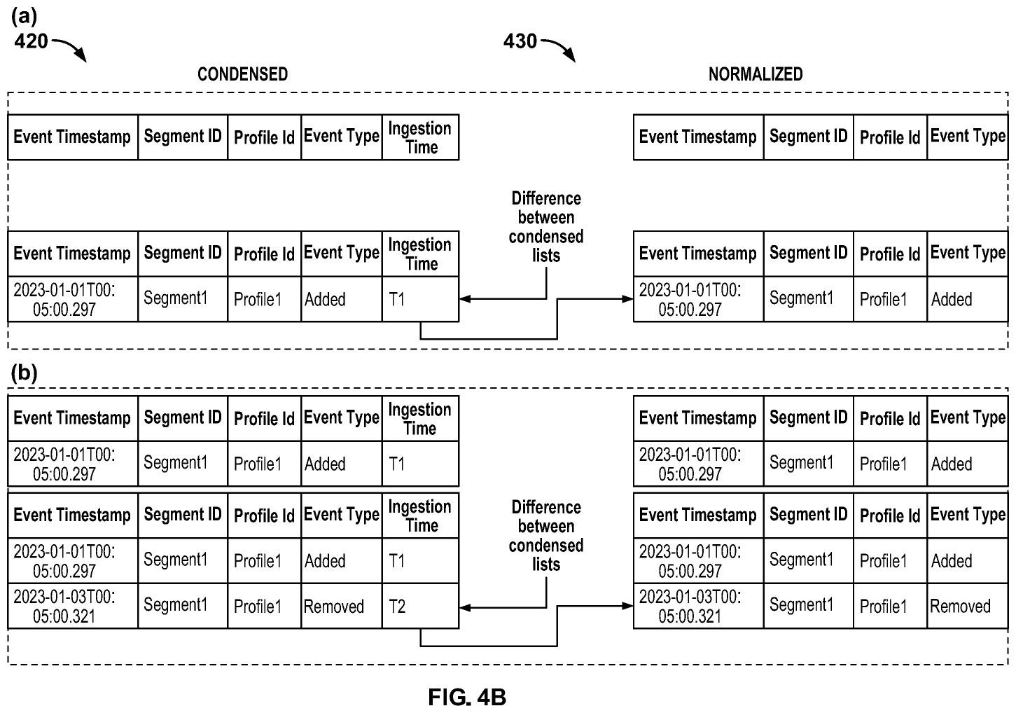

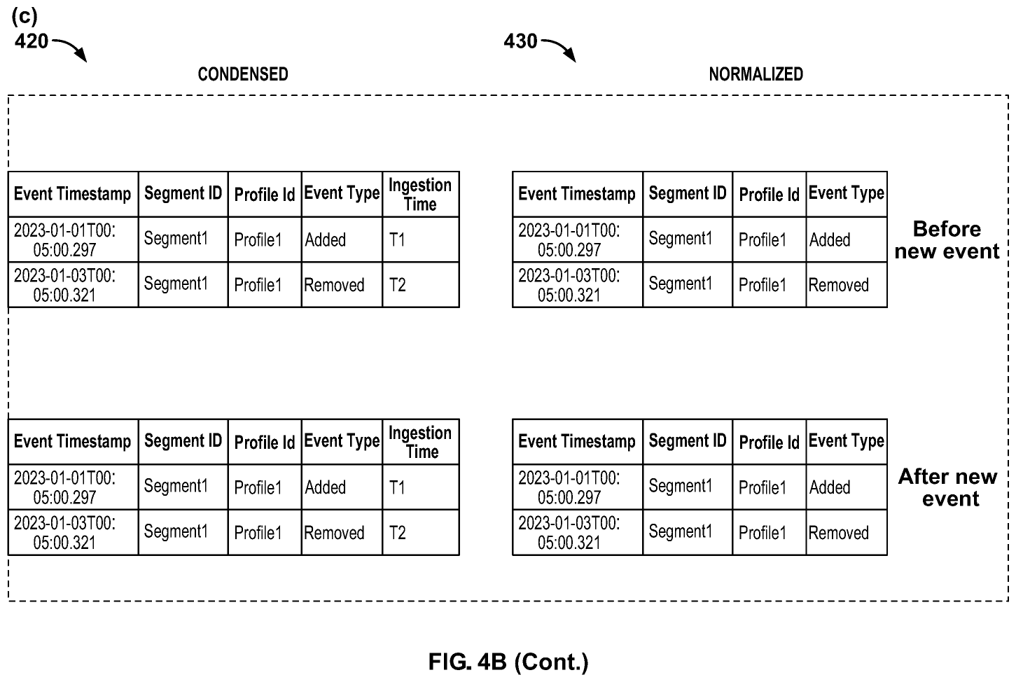

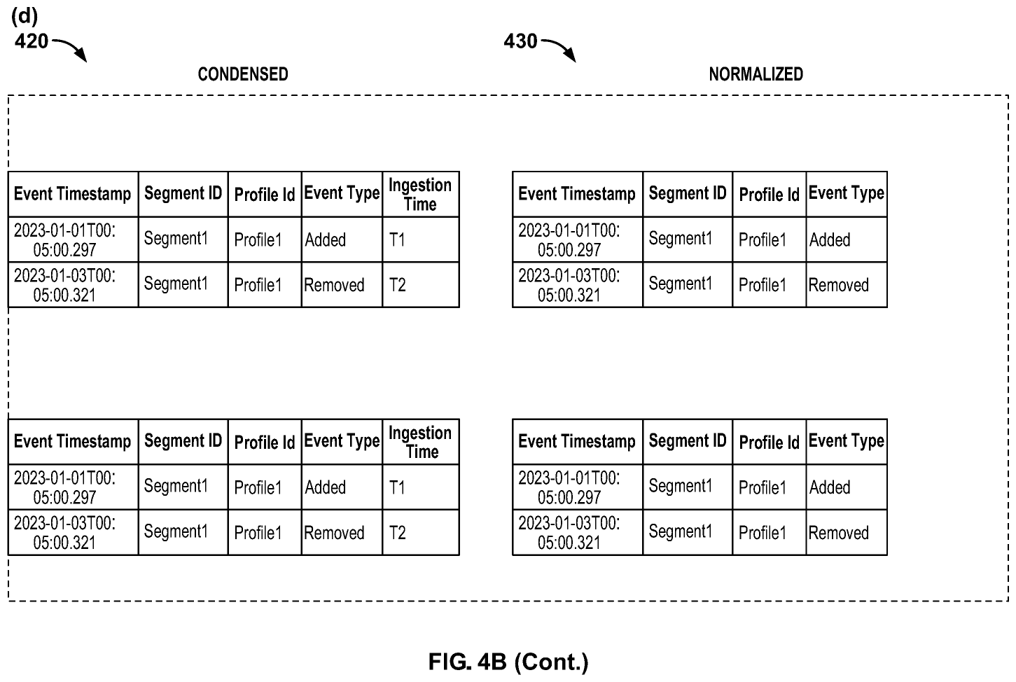

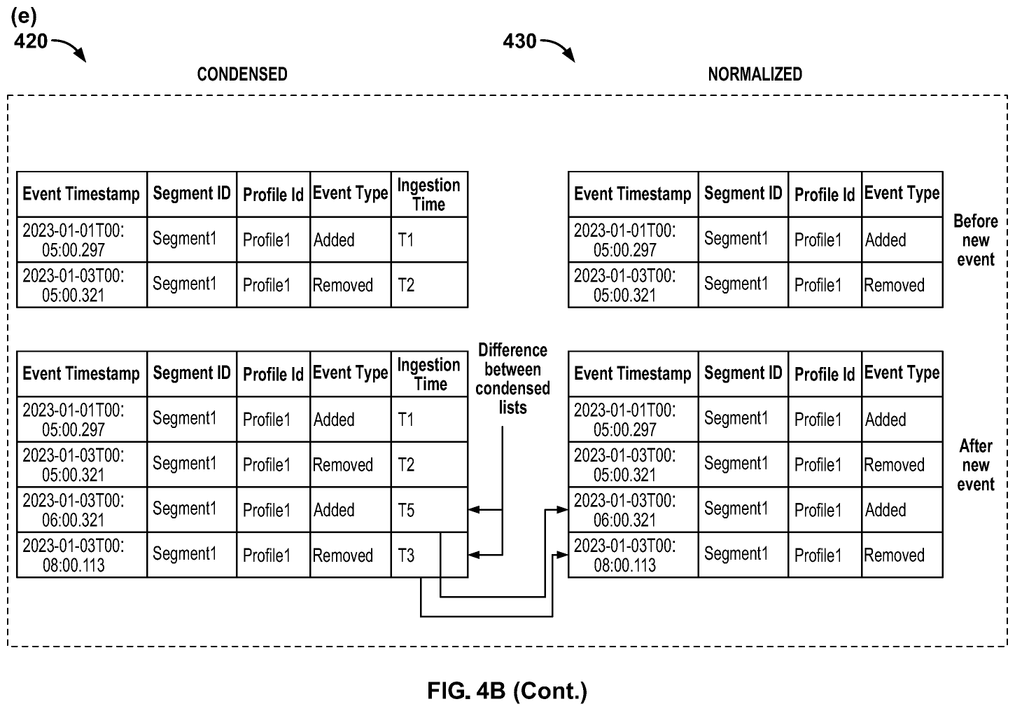

FIG. 2 is a flow chart of a normalizer module 200 for carrying out the preprocessing steps to prepare only valid event data for the database management system in accordance with an embodiment of the invention. In describing the normalizer 200 reference is also made to the landing table 300, history table 410, condensed history table 420, and normalized table 430 shown in FIGS. 3, 4a, 4b. It is also to be understood that although the tables shown in FIGS. 3, 4a, 4b include only one segment ID and one profile ID to facilitate understanding of the invention, the invention is applicable to preprocessing multiple profile IDs and optionally multiple segments. Indeed, in embodiments, upwards of 500,000 records of different segments and member profiles are preprocessed using the systems and steps described herein.

With reference again to FIG. 2, according to step (1), the input to the normalizer 220 is the landing table 210, where new records are obtained since the last run. The time between runs may vary. In embodiments the time between runs ranges from 20-35 minutes. An example of the landing table 300 for ingestion times (time T1 to time T5) is shown in FIG. 3. Each newly ingested record includes a timestamp, audience ID (e.g., segment ID), profile ID (e.g., business/entity ID), and event type (e.g., member added/removed to the segment). In embodiments, the records in the landing table are partitioned based on time.

Step (2) states to read all historic records for memberships present in the batch of new records. The normalizer 220, for each ingestion time, reads a complete listing of the historic records (e.g., historic records 410(a)-410(e)). The normalizer organizes the records by timestamp and condenses the historic events to a condensed history list as shown in 420(a)-420(e). In embodiments, the normalizer (i) searches the history table for matching profile and audience (segment) IDs; (ii) arranges the records by timestamp; and (iii) filters out the duplicative ‘removed’ and ‘added’ events. In embodiments, a duplicative ‘removed’ change event is a removed change event that is preceded by an adjacent removed change event such as the T3, T4 records listed in FIG. 4A, part d. In embodiments, a duplicative ‘added’ change event is an added change event that is preceded by an unclosed added change event. By ‘unclosed’ added change event, it is meant an added change event that does not have a corresponding removed change event. Duplicative ‘removed’ events are filtered out because a member may not be removed when there is not a member in the audience to be removed. A member cannot be removed that is not in the group. Similarly, duplicative ‘added’ events are filtered out because a member cannot be added to the same audience if they are already included in the audience.

This scenario can arise for several reasons as described herein, and generally arises due to the varying computing performance and loads on different servers as well as bugs in the upstream systems. Consequently, there can be substantial delays between when the event occurred and when the event is ingested by the member tracking system.

By way of example, and with reference to ingestion time T4 corresponding to stage (d) shown in FIG. 4B, the condensed history list 420 for new events does not list duplicative events arising from ingestion times T3, T4. The events for T3, T4 as shown in the regular history table 410(d) have been removed to create the condensed history list 420(d).

However, in other instances, and with reference to stage (e) of FIG. 4B, the condensed history list 420 for new events includes new late-arriving event for T5 and previous event T3. It does not list duplicative events arising from ingestion time T4. The event for T4 as shown in 410(e) has been removed to create the condensed history list 420(e).

Next, optionally after each new event or ingestion time, the updated history list 420 is compared to the previous normalized list 430 for differences.

By way of example, and with reference to stage (c) shown in FIG. 4B, the condensed history list for ‘new’ events 420(c) is compared to ‘previous’ normalized table listing 430(c). There are no differences between the previous normalized table listing 430(c) and the condensed history list 420(c), so no events are added to the current normalized table listing.

However, and with reference to stage (e) shown in FIG. 4C, the condensed history list for ‘new’ events 420(e) is compared to ‘previous’ normalized table listing 430(e). The events for ingestion times T5, T3 are not present in the previous normalized table listing 430(e) so they are added to the current or updated normalized table listing.

Using this logic sequence of steps, the normalizer (30, 220) can update the normalized table (e.g., 50, 240, 430) after each new event is received. The pipeline output is the normalized list of valid events where new events that are deemed valid can be both new events and previously invalid and ignored events, like in the illustration described in FIGS. 3, 4B, stage (e). In embodiments, the normalizer updates the normalized table every 20-35 minutes, and more preferably less than 30 minutes. In embodiments, the records in the normalized table are partitioned based on time, similar to the landing table described above.

With reference again to FIG. 2, the normalizer 220 is shown in step 4 to write all records to the history table 230. In embodiments, the records in the history table are not partitioned. The records are managed based on a cluster scheme and in preferred embodiments, the records are clustered based on profile ID and audience ID. In embodiments, the history table 230 is written to last-after updating the normalized table 240 to avoid losing data. In contrast, if we write to the history table before writing to the normalized table, and there is a failure between those writes, the history table will show that the data from this batch has been processed. But the data is not reflected in the normalized table. Consequently, if we try to run the pipeline on that same batch of data, there will be no output to the normalized table, because all of that data is already in the history table. Therefore, in the scenario in which the batch of data was written to the history table first, that data will never get written to the normalized table.

### Aggregation Data Output

With reference again to FIG. 1, once the normalized data table (e.g., 50) of the valid events is stored, database management system 60 aggregates the data. In embodiments, the membership tracking system includes an online analytics processing (OLAP) database programmed and operable to perform aggregations on, optionally, huge datasets in fractions of a second. An example of a OLAP database is, without limitation, ClickHouse or ClickHouse Cloud, both by ClickHouse, Inc. (Amsterdam, NL)

Below are examples of logic rules for aggregating the normalized data 50 in accordance with some embodiments of the invention that are applied in the OLAP.

(i) Size of the collection at a point in time: Take a sum of +1 for each event indicating the addition of an item to the collection from the start of time to the desired point in time. Take a similar sum of −1 for each event indicating the removal of an item from the collection. Add the two sums together (i.e., subtract the total removals from the total additions)—this is the total size of the collection at the point in time.

(ii) Population of the collection at a point in time: Take all the events for the collection from the start of time to the desired point in time. Group these events by their respective items. For example, in embodiments, group these events by profile ID, which typically corresponds to an individual person or business entity. Then, for each group, subtract the count of removal events from the count of addition events. All the items (e.g., people, business entity, or product) for which this group sum is +1 constitute the members of the collection.

(iii) Items added/removed from the collection over a time period: Similar to the previous example (ii), but rather than taking all events from the start of time to a single point in time, take all of the events within the desired time interval. Group them by item, and sum up the events. Items with a group sum of +1 were added during the time interval. Items with a group sum of −1 were removed during the time interval.

The above logic rules and metrics are intended as exemplary only and the invention is intended to include generating other metric data in the database for the items in the collections except where limited in any appended claims. Additionally, now that the population of a collection can be quickly determined as described above, that population can then be used to filter other metric data to get metrics related to items in a collection for the time period(s) that each item was in the collection. To clarify with an example, if the subject collection is a group of sub-users (also referred to as customer) profiles, the membership can be joined against performance metrics such as “Placed Order” metrics, to get all the “Placed Order” metrics that have occurred for profiles in the group over a time period. The subject invention can filter these with very precise time granularity—to the events that occurred for a profile while it was a member of the group.

In an embodiment of the invention, system includes a graphical user interface (GUI) operable to receive a user selection for a group metric, and to compute as described herein the group metric based on the user selection and a preprocessed membership change event database. In embodiments, the GUI is implemented in a portable computing device such as a tablet, mobile phone, or laptop.

Non limiting examples of user selections are date, date range, an interval, and a conversion metric. In embodiments, the user selection is an interval, and the interval is selected from seconds, minutes, hours, days, weeks, months, and years.

In embodiments, the user selection is a conversion metric, and the conversion metric is a placed order.

Non limiting examples of group metrics are: segment growth, added/dropped members from segment, and segment growth by day, dollars ($) spent by segment members, revenue per email recipient, emails received, open rate, click rate, and placed order rate.

In embodiments, an adaptive method comprises at the time the user selection is received via the GUI, querying whether any new change event records have been received since the preprocessed membership data set was previously prepared. If a new change event record has been received, then the method updates the preprocessed membership data set before sending to the OLAP database. If no new change event records have been received since the preprocessed membership data set was previously prepared, then the method does not update the preprocessed membership data set before sending to the OLAP database.

### Examples

FIGS. 5-6 are examples of reports for evaluating metrics of the collection in accordance with embodiments of the invention. With reference to FIG. 5, a graphical user interface (GUI) shows a segment growth report 500 in accordance with an embodiment of the invention. The segment growth report 500 includes a plurality of windows: upper left window 510 shows the size of the segment at the end of the specified time range (total members), the number of members added and removed over that period (along with values comparing these numbers to respective values from the previous time range of the same duration), and a line graph showing the segment size over time; upper right window 520 shows a graph of the number of profiles added and removed from the segment over each day in the time range; and bottom window 530 shows a breakdown by day of the membership changes, showing the total size; the number of profiles added/removed; the net change; and the net change as a percentage of total population size. The user can review these reports and quickly evaluate the impact and potential cause of a change in membership.

FIG. 6 shows a GUI of a segment performance report 600 in accordance with embodiments of the invention. This segment performance report 600 shows metrics for a segment which accurately reflect the membership of that segment over time. The report 600 shows a plurality of performance metrics in different windows including a segment behavior window 610 and channel performance window 620. The segment behavior window 610 shows amount spent by segment members, time between orders, historic CLV, and average order value. The channel performance metric 620 shows emails received, email open rate, click rate, placed order rate, revenue attributed to email, and revenue per email recipient for a given segment over history. In embodiments, the various metrics (examples of which were described above) are collected for each profile ID, and the segment behavior and channel performance can be quickly aggregated in the OLAP database 60 based on the updated/normalized membership change event table, the metrics associated with each profile ID, and the user or subscriber selection 62 (e.g., filter, sort, date range, interval, etc.)

It is to be understood, however, that the above reports and metrics shown in FIGS. 5-6 are examples and the invention is not intended to be limited to these examples except where specifically recited in any appended claims. A wide range of reports may be generated by the database management system in granularity and in seconds or fractions of a second. For example, an additional metric which may be presented in a report is spam complaints for a given segment over history.

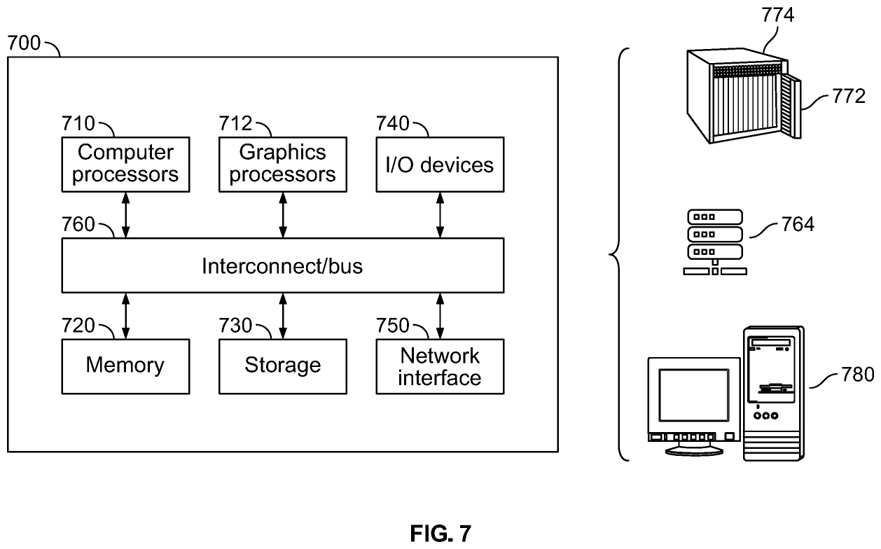

FIG. 7 is a block diagram of a computing system 700 used to implement the techniques/processes described herein in accordance with embodiments of the invention. The computing device 700 is intended to represent various forms of digital computers, such as servers 764, 774, workstations, desktops 780, laptops, and other types of computing devices. The components shown here, their connections and relationships, and their functions, are meant to be exemplary only, and are not meant to limit implementations of the inventions described and/or claimed herein.

The computing device 700 is shown including: a computer processor 710, graphic processor 712, memory 720, storage 730, input output devices 740 and network interface 750.

The processors 710, 712, memory 720, storage 730, and network interface 750 are interconnected using various interconnect busses 760, and may be mounted on a common motherboard or in other manners as appropriate. The processor(s) can process instructions for execution within the computing device 700 to carry out the operations described herein, and including instructions stored in the memory 720 to display graphical information for a GUI on a display unit coupled to the network interface, I/O ports, or dedicated video card (not shown).

The memory 720 stores information within the computing device 700. In some implementations, the memory 720 is a volatile memory unit or units. In some implementations, the memory 720 is a non-volatile memory unit or units. The memory 720 may also be another form of computer-readable medium, such as a magnetic or optical disk.

The storage device 730 can provide mass storage for the computing device 700. In some implementations, the storage device 730 may be or contain a computer-readable medium, such as a hard disk device, an optical disk device, a tape device, a flash memory or other similar solid state memory device, or an array of devices, including devices in a storage area network or other configurations.

In some implementations, a computer program product may also contain instructions that, when executed, perform one or more methods, such as those described above. The computer program product can also be tangibly embodied in a computer- or machine-readable medium or media, such as the memory 720 or the storage device 730.

The input/output devices 740 are connected to the system via an input/output interface. Examples of input/output devices include, without limitation, sensors such as touch screen sensors, geolocation receivers, microphones, speakers, keyboard, mouse, printer, Bluetooth peripherals, and USB devices to communicate with the internal components of the computing device. In some embodiments, a user behavior or selection may be obtained or sensed by the input output devices, and used to form segments and audiences, determine membership change events, and select metrics as described herein.

Network interface 750 can include various communication ports (e.g., USB, Bluetooth, Ethernet, wireless Ethernet). The network interface 750 can allow the processors to access the Internet through wired or wireless connections such as WiFi, 3G, 4G long-term evolution (LTE), 5G, and other wireless interface standard radios as well as Ethernet connection hardware.

The computing device 700 may be implemented in a wide variety of different forms. For example, it may be implemented as a standard server 764 or a desktop computer 780.

In some embodiments, multiple processors and/or multiple buses are combined, as appropriate, along with multiple memories and types of memory. Multiple computing devices may be connected, with each device providing portions of the necessary operations (e.g., as a server bank, a group of blade servers, or a multi-processor system). Examples of server systems for implementing the processes and methods described herein include, without limitation, cloud data centers with rack-mounted servers 764, blade server systems 774, etc.

In embodiments, different servers (optionally at different locations) carry out different steps or processes of the invention. For example, a segmentation server may be programmed and operable to manage the segmentation, a change event collection server may be programmed and operable to record raw change events from the change event data stream, a normalizer server may be programmed and operable to normalize or filter the events, and a database management server may be programmed and operable to manage the database for metrics. In a preferred embodiment, the server may be configured as a server framework, cluster, or distributed computing system of servers or nodes to perform the steps, and serving to distribute workloads consisting of a high number of individualized, parallelizable tasks among the nodes in the cluster. A non-limiting example of a suitable distributed computing system is AWS by Amazon Web Services, Inc. (Seattle, WA). Indeed, the components shown here, their connections and relationships, and their functions, are meant to be exemplary only, and are not meant to limit implementations of the inventions described and/or claimed herein.

### Alternative Embodiments

In another embodiment, the sub-user's actions are sensed. For an embodiment, when the sub-user loads a webpage, user-tracking code is loaded in through a JavaScript bundle and utilized within the browser of the sub-user. For an embodiment, actions of the sub-user on the website of the user can be tracked. In some embodiments, the amount of time a sub-user's cursor hovers over an area (e.g., a window, tab or icon) of the display is detected. Further, in some embodiments, a mobile device of a sub-user can be tracked to determine other possible actions of the sub-user. In some embodiments, the location or distance a sub-user's mobile device is from a known or target location (and the duration) is detected and tracked. In embodiments, forms that have been filled out and submitted to the website of the user can be monitored and tracked. For an embodiment, behavior of the sub-user's internet browser or device (that would affect communication of a message or a sub-user's desired action) can be monitored or tracked. For an embodiment, navigation by the sub-user to a website or URL (universal resource locator) can be sensed, tracked, and monitored. In embodiments, such information can be used to form segments and audiences. In embodiments, such information can be used by the segmentation engine to, for example, determine membership change events for the sub-user, which can then be passed on to the normalizer as described herein.

In embodiments, the system purges select data from the history table. In embodiments, select data to purge or delete includes, without limitation, data corresponding to deleted audiences or segments. For example, if a user no longer requests an audience (or a segment) to be tracked, the data associated with the deleted audience (or segment) is no longer needed and can be deleted.

Closed pair data may also be deleted. That is, closed pairs of added/removed membership change events prior to a designated time (or “cut-off”’) in the past are deleted. Without intending to be bound to theory, this is because if an added event has been followed by a removed event, then those paired events will not be needed for normalization logic, described herein. In contrast, if one added event is present without a corresponding removed event, the added event should be retained so that a late arriving removed event is not incorrectly filtered that should be associated with this added event.

Purging can be performed one or more times. Purging can be performed automatically regularly or periodically or, on demand, by a user via an input device. In embodiments, purging is performed every 6-12 months, or longer.

The subject invention has been described above in connection with audience-type collections but it is to be understood that the invention can be extended to non-audience collection use cases, such as product collections. For example, a user may add and remove products in a collection, and the system could track the membership of that collection, and join it to metric data for performance reporting. For example, a collection could be tracked for “all products ordered by someone in the US over the past 90 days”. Indeed, many different types of collections could be tracked and grouped by a wide range of different items (e.g., location, time period, etc.) in accordance with the subject invention.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in another order than that specifically described above. Additionally, any of the components and steps described herein may be combined with one another in any logical manner except where such components or steps would be exclusive to one another. Accordingly, the scope and spirit of the invention should be judged in terms of the claims, which follow as well as the legal equivalents thereof.

What is claimed is:

1. A computer-implemented method for improving the processing speed of an analytics processing database for tracking membership of a collection based on new records corresponding to new membership change events, the method comprising:
receiving the new records for membership change events;
preprocessing, on a server, the new records to create a normalized data table, wherein the preprocessing comprises:
determining invalid records by reading historic records for memberships present in the new records;
creating normalized records by filtering out invalid records from the historic records and the new records; and
writing the normalized records to the normalized data table;
sending the normalized data table to the analytics processing database;
receiving a user selection via a user input device; and
computing, on the analytics processing database, at least one metric for the collection based on the user selection and the normalized data table.

2. The method of claim 1, wherein the computing comprises computing at least one metric from the following: size of the collection, population of the collection, and population for the collection for a time period.

3. The method of claim 1, wherein the computing comprises computing size of the collection, and the method further comprises displaying growth of the collection.

4. The method of claim 2, comprising displaying at least one channel performance metric selected from the group comprising revenue attributed to email, email open rate, click rate, and placed order rate.

5. The method of claim 1, wherein the membership change events comprise members added and members removed, and wherein the determining invalid records comprises:
grouping historic records and new records by profile ID and Segment ID;
chronologically arranging the historic records and new records together per group;
identifying the invalid records, in each group, as:
(i) each removed change event that is not preceded by an added change event; and
(ii) each added change event if preceded by an unclosed added change event.

6. The computer-implemented method of claim 1, wherein the collection is an audience.

7. The computer-implemented method of claim 1, further comprising continuously reading new records, and generating an initial set of records of membership change events after reading new records.

8. The computer-implemented method of claim 7, wherein the initial set of records are generated based on previously stored membership data of the collection.

9. The method of claim 1, further comprising creating a history table comprising the historical records, and wherein the new records are written to the history table.

10. The method of claim 9, further comprising purging the history table.

11. The method of claim 1, wherein the computing step is performed in under 1 second.

12. A system for improving the processing speed of a database management system operable to compute a metric of a collection, the system comprising:
a new change event data repository where new membership change events are received and recorded to a raw event table;
a historical change event data repository where the new membership change events and existing membership change events are saved in a historical event table;
a normalizer module operable to create a normalized event table by filtering out invalid membership change events from the historical event table;
a normalized change event data repository for recording the normalized event table; and
a database management system operable to compute at least one metric based on the normalized event table from the normalized change event data repository.

13. The system of claim 12, wherein the normalizer module is operable to:
group historic membership change events and new membership change events by profile ID and Segment ID;
chronologically arrange the historic membership change events and new membership change events together per group;
identify the invalid membership change events, in each group, as:
(i) each removed change event that is not preceded by an added change event; and
(ii) each added change event if preceded by an unclosed added change event; and
filter out the invalid membership change events.

14. The system of claim 12, wherein the processor is programmed and operable to display growth of the collection responsive to a user selection.

15. The system of claim 12, further comprising a computing device programmed and operable with the database management system to receive a user selection, and to display the metric.

16. The system of claim 15, wherein the computing device is a portable computing device selected from the group consisting of a tablet and mobile phone.

17. The system of claim 12, further comprising a segmentation engine programmed and operable to define a member segment based on a user instruction.

18. The system of claim 17, wherein the segmentation engine is further programmed and operable to determine a new membership change event based on automatically detecting an action of a sub-user, and to write the new membership change event to the raw data repository for preprocessing.

19. The system of claim 12, wherein the normalized change event data repository applies a time-based partitioning scheme for recording a normalized event table.

20. The system of claim 19, wherein the historical change event data repository applies a data clustering scheme for saving the new membership change events and existing membership change events in the historical event table.
